(19) United States
(12) Patent Application Publication
(10) Pub. No.: US 2023/0266800 A1
(43) Pub. Date: Aug. 24, 2023

(54) ELECTRONIC DEVICES WITH ROTARY MAGNETIC LATCHES

(71) Applicant: Apple Inc., Cupertino, CA (US)

(72) Inventors: James T. HANDY, San Francisco, CA (US); Lucas R. COMPTON, San Francisco, CA (US)

(21) Appl. No.: 17/652,062

(22) Filed: Feb. 22, 2022

(51) Int. Cl. G06F 1/16; H01F 7/02

(52) U.S. Cl. CPC G06F 1/1679; H01F 7/02

(57) ABSTRACT

This application relates to latch systems that secure together housing components of an electronic device. A latch and a magnet (coupled with the latch) are secured with a housing component by, for example, a post that extends from the housing component. The latch and the magnet can move (i.e., rotate) with respect to the housing component. As an example, prior to a tool applying an external magnetic field external to the electronic device, the latch is coupled to a first housing component and is engaged with a second housing component, thereby mechanically interlocking the first and second housing components. However, when the tool applies a rotational magnetic field to the magnet (that is coupled with the latch), the magnet and the latch rotate, thereby causing the latch to disengage from the second housing component. This allows the first and second housing components to decouple from each other.

### FIELD

The described embodiments relate generally to latches for electronic devices. More particularly, the present embodiments relate to magnetic latches used to secure together components (e.g., housing components) of an electronic device. Additionally, based on an applied magnetic field, magnetic latches can be actuated, thus allowing the housing components to be separated for rework operations and/or upgrading of internal components.

### BACKGROUND

Electronic devices with multiple housing components often use fasteners (e.g., screws) to secure together the housing components. While fasteners are generally reliable, they can lead to some issues. For example, fasteners require one or more openings in at least one of the housing components, which leaves an electronic device susceptible to ingress of liquids or other contaminants.

Some solutions provide an alternative to fasteners and further reduce the need for openings. For example, spring clips can be coupled to one of the housing components and fastened to the other housing component, thereby securing together the housing components. However, spring clips require a specific tool/machine to attach the spring clip to the extension. Further, the de-coupling between the spring clip and the extension can be difficult, leading to rework challenges. Also, as housing components become thinner, the force applied by the tool used with the spring clip can cause the housing component to deflect, or deviate, from the original shape.

### SUMMARY

This paper describes various embodiments that relate to a latch system used to secure together housing components. In response to a rotational magnetic field in one direction, a magnet and a latch are rotated in a position in which the latch mechanically interlocks the housing components together. Additionally, in response to a rotational magnetic field in the opposite direction, the magnet and the latch are rotated to a different position in which the mechanical interlocking provided by the latch is removed, thereby allowing housing components to decouple, or detach, from each other. The decoupling provides access to one or more components within a volume defined by the housing components.

In some embodiments of the present disclosure, an electronic device is described. The electronic device may include a housing that defines an internal volume. The housing may include a first housing component. The housing may further include a second housing component coupled with the first housing component. The second housing component may include a slot. The electronic device may further include a latch system disposed in the internal volume. The latch system may include a post extending from the first housing component. The latch system may further include a magnet coupled with the post. The latch system may further include a latch coupled with the magnet. In some embodiments, a first position includes the latch located in the slot. In some embodiments, a second position comprises the latch removed from the slot based on movement of the magnet.

In other embodiments of the present disclosure, an electronic device is described. The electronic device may include a display housing that carries a display. The electronic device may further include a base portion rotationally coupled to the display. The base portion may include a first housing component. The base portion may further include a second housing component that combines with the first housing component to define an internal volume. The electronic device may further include a latch system disposed in the internal volume. The latch system may include a post extending from the first housing component. The latch system may further include a magnet coupled with the post. The latch system may include a latch coupled with the magnet. The latch can couple the first housing component with the second housing component. In some embodiments, responsive to an external magnetic field applied to the magnet, the latch moves and decouples from the second housing component.

In other embodiments of the present disclosure, a method for accessing a component located in an electronic device is described. The method may be implemented by the electronic device. The electronic device may include a magnet, a latch, a first housing component, and a second housing component. The method may include receiving, by the magnet, an external magnetic field from an external magnet that is external to the electronic device. The method may further include actuating, based on the external magnetic field, the magnet. The method may further include actuating, based on actuation of the magnet, the latch relative to the first housing component. The method may further include disengaging the latch, based on actuation of the latch, from the second housing component.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates an isometric view of an embodiment of an electronic device;

FIG. 2 illustrates a partial cross-sectional view of the electronic device shown in FIG. 1, showing a latch system, in accordance with some described embodiments;

FIG. 3 illustrates a cross-sectional view of the electronic device shown in FIG. 1, taken along line 3-3, showing additional features of the latch system, in accordance with some described embodiments;

FIG. 4 illustrates a plan view of the latch system, showing additional features;

FIG. 5 illustrates a plan view of the latch system shown in FIG. 4, further showing movement of the magnet and the latch, in accordance with some described embodiments;

FIG. 6 illustrates a plan view of the electronic device, showing several latch systems positioned in the base portion, in accordance with some described embodiments;

FIG. 7 illustrates a partial cross-sectional view of an electronic device, showing a latch system interacting with a tool, in accordance with some described embodiments;

FIG. 8 illustrates a partial cross-sectional view of the electronic device shown in FIG. 7, showing the housing components separated;

FIG. 9 illustrates a partial cross-sectional view of an electronic device, showing a latch system integrated with a component of the electronic device, in accordance with some described embodiments;

FIG. 10 illustrates a plan view of an alternate embodiment of a latch system, showing the latch system with a biasing component, in accordance with some described embodiments;

FIGS. 11A and 11B illustrate a plan view of yet another alternate embodiment of a latch system, showing the latch system driving a latch in an alternate direction, in accordance with some described embodiments;

FIGS. 12A and 12B illustrate an isometric view of an alternate embodiment of an electronic device;

FIG. 13 illustrates an isometric view of yet another alternate embodiment of an electronic device;

FIG. 14 illustrates a flowchart showing a method for accessing a component located in an electronic device, in accordance with some described embodiments; and

FIG. 15 illustrates a block diagram of an electronic device, in accordance with some described embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

This application is directed to incorporating latches used to secure together two or more components of an electronic device. Electronic devices described herein may refer to desktop computing devices, laptop computing devices, mobile wireless communication devices (e.g., smartphones, tablet computing devices), and display devices (e.g., computing devices with displays, standalone displays), as non-limiting examples. The components may include housing components used to form a housing, or enclosure, to store internal components of an electronic device.

Traditional electronic devices rely upon fasteners, or screws, to secure together housing parts. However, electronic devices described herein replace fasteners with one or more latches located within the electronic device. Unlike fasteners, the latches do not require openings in the housing components. Latches can be contained within the housing (i.e., between the housing components secured by the latches), thereby eliminating the need for fastener openings. Beneficially, the latches allow for electronic devices to reduce the number of ingress points.

In order to drive the latches to a desired location, each latch may be secured with a magnet. Using a magnetic tool, the magnet (coupled to the latch) can move (i.e., rotate), causing the latch to move in conjunction with the magnet. In this manner, when two housing components (i.e., a first and second housing component) are assembled, the latch (secured to the first housing component) can be driven using the magnetic tool, causing the latch to secure with the second housing component. Subsequently, the magnetic tool can reverse direction, causing the magnet and the latch to rotate in the opposite direction, thereby releasing the latch from the second housing component. When the latch is released from the second housing component, the first and second housing components can be decoupled, or detached, from each other.

In addition to reducing the number of ingress points, the latch provides other advantages. For example, the latch and the magnet are disposed within the electronic device. In this manner, the exterior of the electronic device render fewer visible locations in which the housing components are secured together, which may enhance the overall aesthetics of the electronic device. Additionally, the ease of rework operations may be facilitated using latches as compared to fasteners, as the fasteners may require additional manual labor (and associated time) to remove and are susceptible to being lost. By minimizing the time used to access electronic device components for rework operations, electronic device can be repaired and/or upgraded with greater ease. Additionally, latches provide minimal, if any, installation forces when actuated. This may prevent bending/bowing of housing components during assembly.

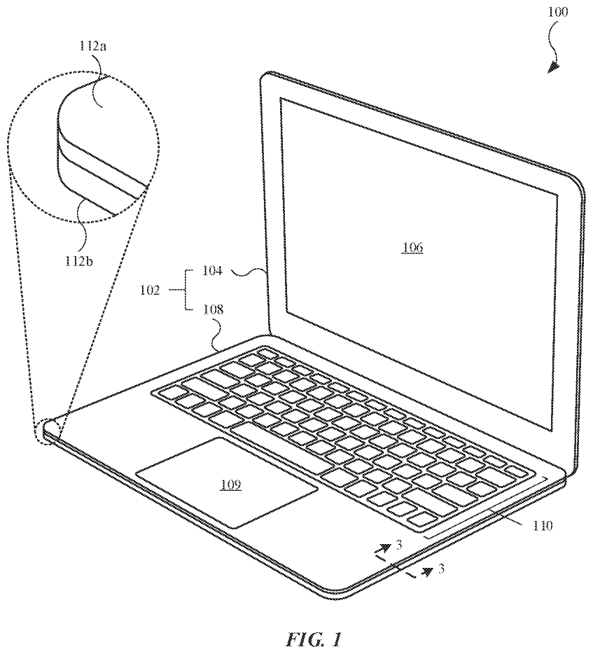

These and other embodiments are discussed below with reference to FIGS. 1-15. However, those skilled in the art will readily appreciate that the detailed description given herein with respect to these figures is for explanatory purposes only and should not be construed as limiting.

FIG. 1 illustrates an isometric view of an embodiment of an electronic device 100. Electronic device 100 may include a laptop computing device. However, in other embodiments, electronic device 100 may take the form of a different computing device, such as a desktop computing device, a mobile wireless communication device, or a display device, as non-limiting examples.

Electronic device 100 may include a housing 102 composed of several housing components. The material makeup of the various components (discussed below) housing 102 may include non-magnetic metals (e.g., aluminum or aluminum alloy) or non-metals, as non-limiting examples. Generally, housing 102 may include a material(s) with low magnetic permeability such that little or no magnetism is induced in the material(s).

As shown, housing 102 includes a display housing 104 that carries a display 106 designed to present visual information in the form of textual images, still images, and/or motion images (i.e., video). Additionally, housing 102 includes a base portion 108 rotationally coupled to display housing 104, thereby allowing electronic device 100 to be positioned in an open position (shown in FIG. 1) or a closed position. Base portion 108 carries input devices, such as a track pad 109 and a keyboard 110. As shown in the enlarged view, base portion 108 includes a housing component 112a and a housing component 112b, also referred to as a top case and a bottom case, respectively. Housing components 112a and 112b combine to define an internal volume, or storage space, for internal components of electronic device 100, such as a central processing unit (“CPU”), graphics processing unit (“GPU”), additional processing circuitry, memory circuitry, wired and wireless communication components, and flexible circuitry to connect at least some of the components, as non-limiting examples.

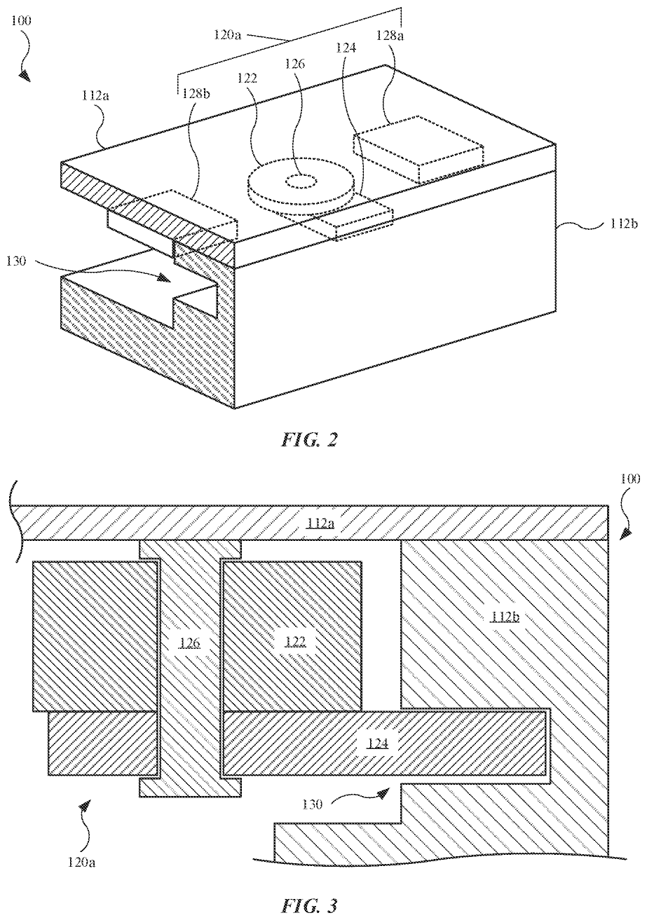

FIG. 2 illustrates a partial cross-sectional view of electronic device 100 shown in FIG. 1, showing a latch system 120a, in accordance with some described embodiments. Latch system 120a is designed to hold together some regions of housing 102 (shown in FIG. 1). As shown in FIG. 2, latch system 120a can mechanically interlock housing components 112a and 112b. Latch system 120a includes several components and features. For example, latch system 120a includes a magnet 122 and a latch 124. Magnet 122 and latch 124 are secured with housing component 112a by a post 126, also referred to as an extension or a pin. Further, latch system 120a may be described as a rotary magnetic latch. For example, magnet 122 and latch 124 are movable (e.g., rotatable) relative to post 126. Moreover, magnet 122 and latch 124 can move simultaneously and in conjunction with each other. In this manner, magnet 122 and latch 124 may be affixed together. However, in some situations, it may be desirable to limit or prevent movement of latch 124. In this manner, latch system 120a may further include a magnet 128a and a magnet 128b designed to resist, or counteract, certain undesired movement by forming a magnetic circuit with magnet 122.

Also, FIG. 2 shows housing components 112a and 112b assembled together and mechanically interlocked by latch 124.

Each of magnets 122, 128a, and 128b may include a permanent magnet, such as a rare Earth magnet (e.g., neodymium), or a magnetized material (e.g., magnetized steel), as non-limiting examples. Latch 124 may act as a fastener, a bar, or a bolt. In this manner, latch 124 can be positioned in, including engaged with, housing component 112b. As shown, housing component 112b includes a slot 130 formed in housing component 112b. Slot 130 defines an indentation or undercut region designed to receive latch 124.

FIG. 3 illustrates a cross-sectional view of electronic device 100, taken along line 3-3, showing additional features of latch system 120a, in accordance with some described embodiments. As further illustrated, post 126 is secured with and suspended from housing component 112a. Also, magnet 122 and latch 124 are secured with post 126, and accordingly are suspended from housing component 112a. In this regard, magnet 122 and latch 124 include a respective opening through which post 126 passes. Also, latch 124 is positioned in slot 130 of housing component 112b. As a result of the position of latch 124, housing components 112a and 112b are mechanically interlocked. Beneficially, the use of latch system 120a can reduce, and in some cases eliminate, the need for fasteners or clips to secure together housing components 112a and 112b, thereby reducing or eliminating openings in housing component 112b and thus reducing the number of ingress points into electronic device 100. A tool (not shown) can be used to actuate magnet 122 and latch 124 to position latch 124 in the position shown in FIGS. 2 and 3. Additionally, the tool can actuate latch 124 out of slot 130 to remove the mechanical interlocking. This will be shown and described below.

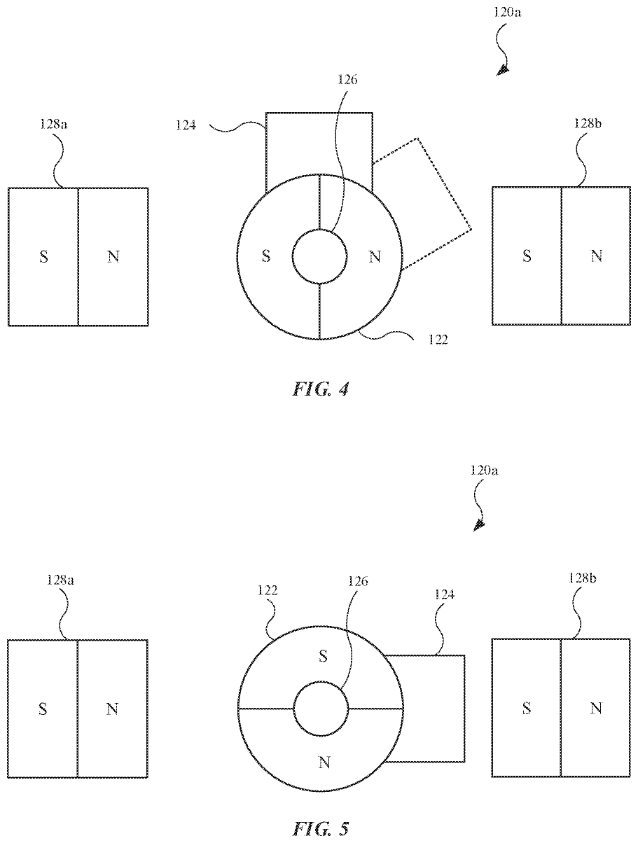

FIG. 4 illustrates a plan view of latch system 120a, showing additional features. As shown, magnet 122 includes a North-facing polarity, or North pole, denoted as “N.” Additionally, magnet 122 includes a South-facing polarity, or South pole, denoted as “S.” Also, magnet 122 may include a cylindrical magnet with a circular cross section. Moreover, in the embodiment shown in FIG. 4, magnet 122 is magnetized into North and South poles separated by the width, or diameter, of magnet 122. Accordingly, magnet 122 may include a diametrically opposed magnet.

In addition to magnet 122, latch system 120a further includes magnets 128a and 128b that surround magnet 122. The respective positions and polarities of magnets 128a and 128b are designed to magnetically attract magnet 122. For example, the North pole of magnet 128a is aligned with the South pole of magnet 122, while the South pole of magnet 128b is aligned with the North pole of magnet 122. Additionally, based on a combination of the magnetic field strength of magnets 128a and 128b as well as the distance of each of magnets 128a and 128b from magnet 122, magnets 128a and 128b each form a magnetic circuit with magnet 122. As a result, magnets 128a and 128b can resist at least some rotational movement of magnet 122. For example, when electronic device 100 (shown in FIG. 1) is exposed to external force (e.g., drop event), the external force may cause magnet 122 to rotate about post 126. As a result, latch 124 may also rotate. However, magnets 128a and 128b can resist at least some of the external, thereby minimizing or preventing rotation of magnet 122. By minimizing or preventing rotation of magnet 122, the rotation of latch 124 is minimized or prevented, respectively. In this manner, latch 124 may remain in a desired position, i.e., in slot 130 of housing component 112b (shown in FIGS. 2 and 3). Moreover, when magnet 122 and latch 124 are rotated (as indicated by the dotted lines showing an alternate position for latch 124), magnets 128a and 128b can apply a force (by way of their respective magnetic fields) to rotate magnet 122 and latch 124 back to their original positions (shown in FIG. 4).

FIG. 5 illustrates a plan view of latch system 120a shown in FIG. 4, further showing movement of magnet 122 and latch 124, in accordance with some described embodiments. As shown, magnet 122 and latch 124 are rotated about post 126. To magnet 122 and latch 124 to rotate in this manner, an external force is applied. For example, a tool (not shown in FIG. 5) that includes a magnet can apply a magnetic field to magnet 122, causing magnet 122 to rotate, which causes latch 124 to simultaneously rotate with magnet 122. In this manner, the applied magnetic field provided by the tool may include a rotating magnetic field that imparts a rotational force to magnet 122 and latch 124. In order to rotate magnet 122 and latch 124, the magnetic field provided by the tool includes a force that overcomes that of magnets 128a and 128b (i.e., force provided by their respective magnetic fields), as well as other forces (e.g., gravitational forces, frictional forces between post 126 and magnet 122, and/or frictional forces between post 126 and latch 124, as non-limiting examples). Also, based on the position shown in FIG. 5, latch 124 can be removed from slot 130 (shown in FIGS. 2 and 3). While latch 124 is shown positioned approximately 90 degrees relative to its prior position (shown in FIG. 4), any position of latch 124 that removes latch 124 from slot 130 may be acceptable for the purposes of remove a mechanical interlocking between housing components 112a and 112b (shown in FIGS. 2 and 3).

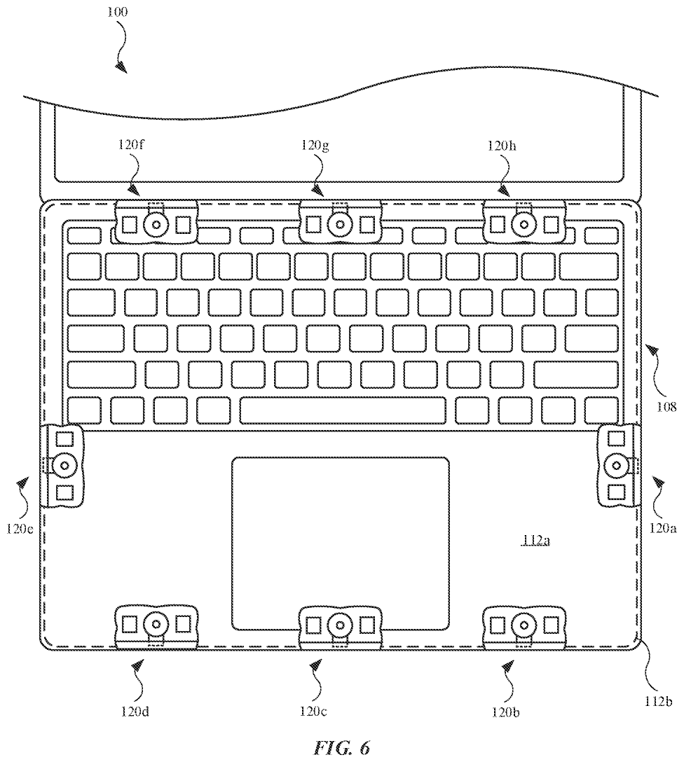

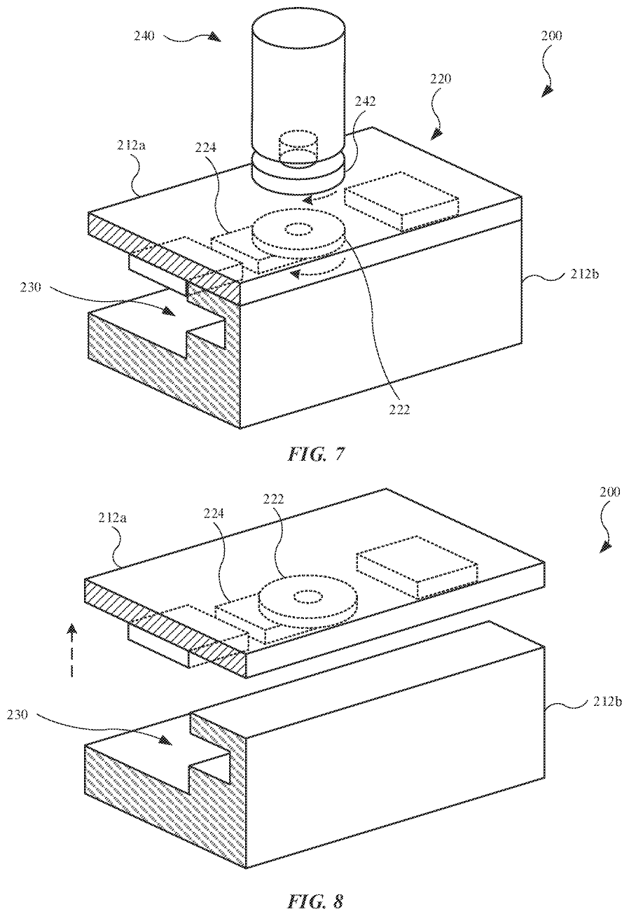

FIG. 6 illustrates a plan view of electronic device 100, showing several latch systems positioned in base portion 108, in accordance with some described embodiments. As shown, electronic device 100 includes latch systems 120a, 120b, 120c, 120d, 120e, 120f, 120g, and 120h disposed throughout base portion 108. Latch systems 120b, 120c, 120d, 120e, 120f, 120g, and 120h may include any functions and features shown and described for latch system 120a (shown in FIGS. 2-5). Latch systems 120a, 120b, 120c, 120d, 120e, 120f, 120g, and 120h can (collectively) mechanically interlock housing component 112a and housing component 112b (shown as a dotted line). Although a discrete number of latch systems are shown, the number of latch systems may vary in other embodiments. Accordingly, electronic device 100 may include one or more latch systems.

FIG. 7 illustrates a partial cross-sectional view of an electronic device 200, showing a latch system 220 interacting with a tool 240, in accordance with some described embodiments. Electronic device 200 may include any components and features shown and described for electronic device 100 (shown in FIG. 1), including those shown for latch system 120a (shown in FIGS. 2-6). Tool 240 may include a magnetic tool than can be used (externally) with electronic device 200. In this manner, tool 240 includes a magnet 242 (defined as an “external magnet” based on its location outside electronic device 200). When placed in proximity to a magnet 222 of latch system 220, magnet 242 can magnetically couple with magnet 222 through housing component 212a. In this regard, magnet 222 forms a magnetic circuit by an external magnetic field provided by magnet 242. Also, magnet 242 can be actuated/moved by a motor (not shown in FIG. 7) of tool 240 or by means (automated or manual). For example, tool 240 can provide a rotary magnetic field based on rotating magnet 242. The actuation/movement of magnet 242 causes a corresponding actuation/movement (e.g., rotation) of magnet 222 and latch 224 of latch system 220. For example, an arrow (not labeled) indicates the directional movement of magnet 242, and an additional arrow (not labeled) indicates a corresponding directional movement of magnet 222 and latch 224. As a result of this movement, latch 224 is removed from slot 230 of housing component 212b.

FIG. 8 illustrates a partial cross-sectional view of electronic device 200 shown in FIG. 7, showing the housing components 212a and 212b separated. As shown, due to the movement of magnet 222 and latch 224 caused by tool 240 (shown in FIG. 7), the mechanical interlocking provided by latch 224 is removed and housing component 212a can be moved away from housing component 212b. It should be noted that when additional latch systems are present in electronic device 200, the additional latches (similar to latch 224) must also be driven out of slot 230 (or another similar slot) in order to separate housing component 212a from housing component 212b. It should be noted that when additional latch systems are present in an electronic device (e.g., electronic device 200), tool 240 may interact individually with each additional latch system (similar to the interaction with latch system 220). Alternatively, tool 240 may be modified to include and actuate additional magnets (similar to magnet 242) for each latch system.

Referring again to FIGS. 2 and 3, it can be seen that magnet 122 and latch 124 define a position in which latch 124 is engaged with housing component 112b when it is positioned within slot 130, thereby mechanically interlocking housing components 112a and 112b. Conversely, FIGS. 7 and 8 show latch 224 (similar to latch 124) defining an alternate position in which magnet 222 and latch 224 are moved (i.e., rotated), and latch 224 is disengaged with housing component 212b and is no longer within slot 230, thereby allowing housing components 212a and 212b to be separated.

Although the described embodiments show a particular housing component carrying the latch system and another housing component having a slot, it should be noted that electronic devices described herein may be modified such that the latch system and the slot can be interchanged.

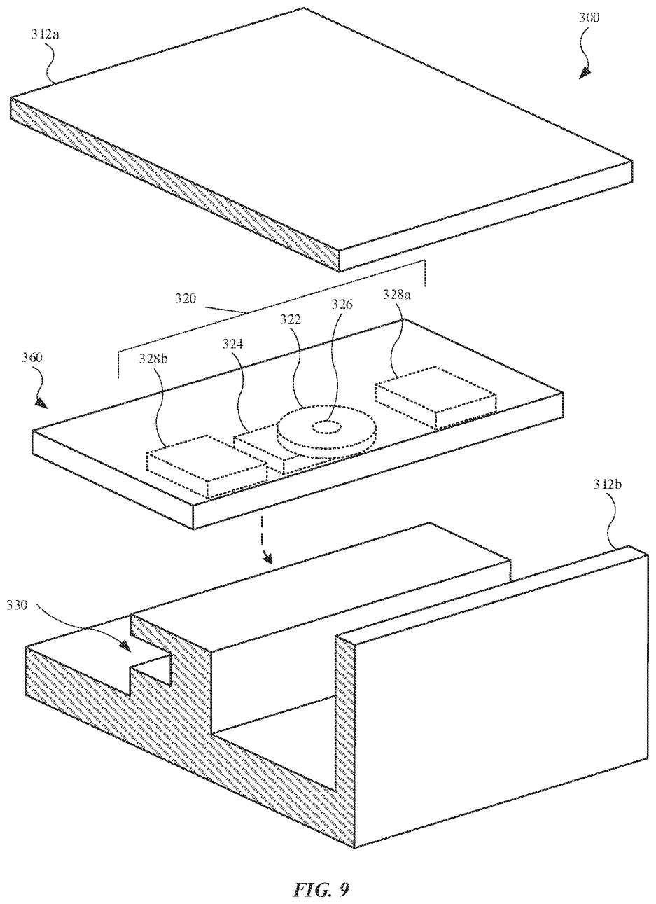

FIG. 9 illustrates a partial cross-sectional view of an electronic device 300, showing a latch system 320 integrated with a component 360 of electronic device 300, in accordance with some described embodiments. Component 360 may represent an internal component of electronic device 300, such as a battery, a circuit board, or an audio module (e.g., speaker), as non-limiting examples. As shown, latch system 320 is secured with a surface (e.g., underside) of component 360. Latch system 320 may include any component(s) shown and described herein for a latch system. For example, latch system 320 may include a magnet 322, a latch 324, a post 326, and magnets 328a and 328b. Further, latch 324 may be driven by any means shown and described herein.

Similar to prior embodiments, electronic device 300 includes a housing component 312a and a housing component 312b. Although not shown, housing components 312a and 312b may be secured together by one or more latch systems, one or more fasteners, and/or one or more spring clips. In order to secure component 360 within electronic device 300, latch system 320 (representing one or more latch systems) can secure with one of the housing components 312a and 312b. For example, housing component 312b includes a slot 330 (similar to prior embodiments of a slot) that can receive latch 324 and mechanically interlock component 360 with housing component 312b. Moreover, latch 324 can be subsequently driven, thereby allowing component 360 to decouple from housing component 312b. Accordingly, some latch systems described herein can be used to not only mechanically interlock housing components of an electronic device, but also to mechanically interlock electronic device components to a housing component of an electronic device.

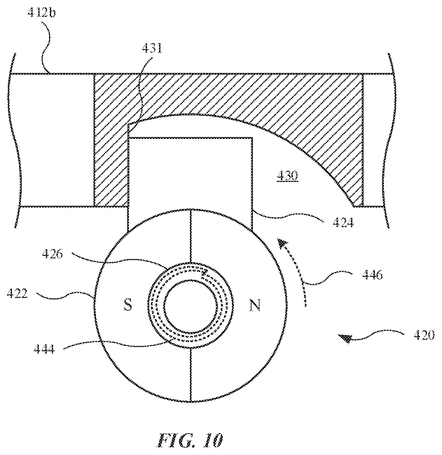

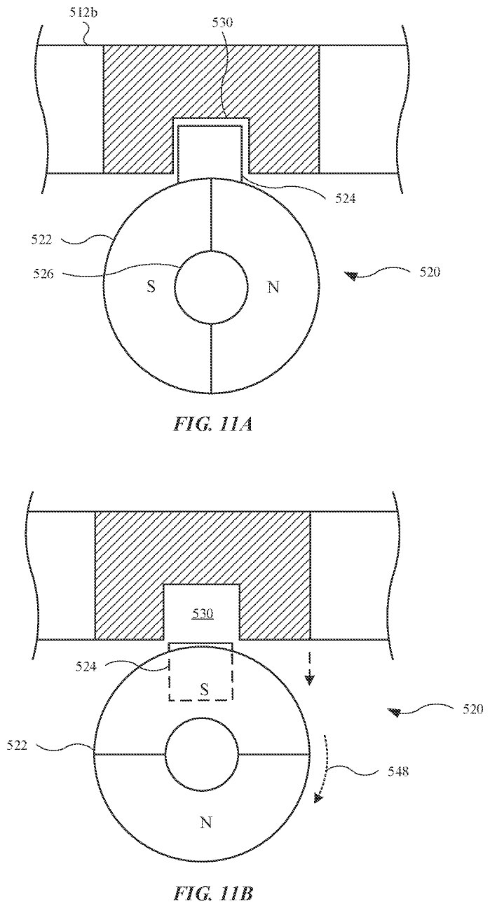

FIGS. 10, 11A, and 11B show and describe alternate latch systems. The latch systems shown and described in FIGS. 10, 11A, and 11B may be substituted for other latch systems shown and described herein, and accordingly may be used in electronic devices described herein.

FIG. 10 illustrates a plan view of an alternate embodiment of a latch system 420, showing latch system 420 with a biasing component 444, in accordance with some described embodiments. As shown, latch system 420 includes a magnet 422, a latch 424, and a post 426. Biasing component 444 (shown as dotted lines) may include a spring or some other mechanism that provides a pre-loaded force to magnet 422 and latch 424. Further, biasing component 444 may include a helical shape and may at least partially wrap around post 426 and provide a biasing force to latch 424 in the direction of the arrow 446. In this manner, when latch 424 is positioned in a slot 430 of a housing component 412b, biasing component 444 causes latch 424 to remain in slot 430, and further, to engage a wall 431 defined by slot 430. As a result, the likelihood of latch 424 moving due to unintended consequences (e.g., external forces from a drop event) decreases. It should be understood, however, that tools described herein may provide a magnetic field that provides a rotational force to magnet 422 to overcome the force provided by biasing component 444, which can remove latch 424 from slot 430.

FIGS. 11A and 11B illustrate a plan view of yet another alternate embodiment of a latch system 520, showing latch system 520 driving a latch 524 in an alternate direction, in accordance with some described embodiments. FIG. 11A shows latch system 520 with a magnet 522, a latch 524, and a post 526, with latch 524 positioned in a slot 530 of a housing component 512b. Rather than rotate with magnet 522 (similar to prior embodiments), latch 524 is designed to move perpendicular (or at least substantially perpendicular) with respect to magnet 522 and/or post 526. For example, FIG. 11B shows magnet 522 rotated approximately 90 degrees (compared to its original position in FIG. 11A) in the direction of the arrow 548. The movement of magnet 522 causes latch 524 to move toward magnet 522 (e.g., into or below magnet 522) and retract from slot 530. This may allow for a reduced size or footprint of latch 524 and/or slot 530.

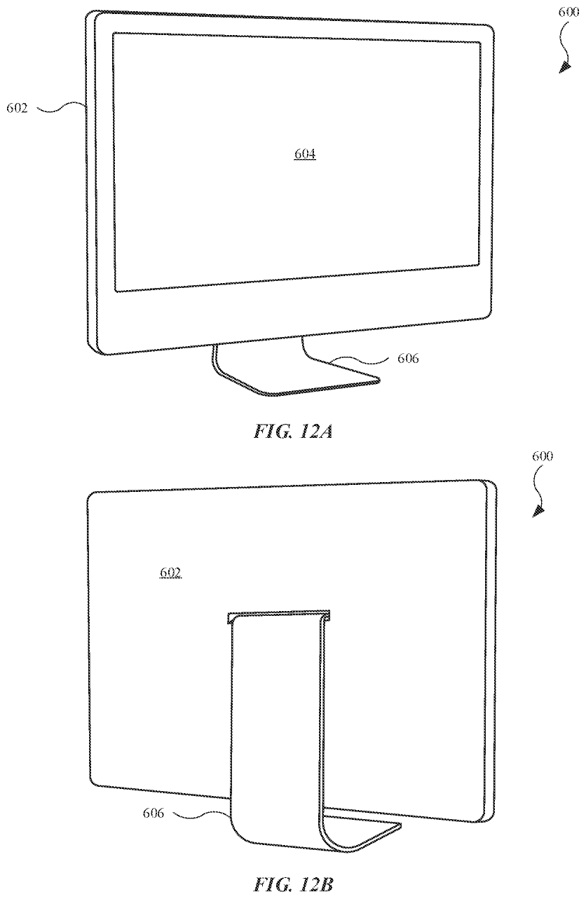

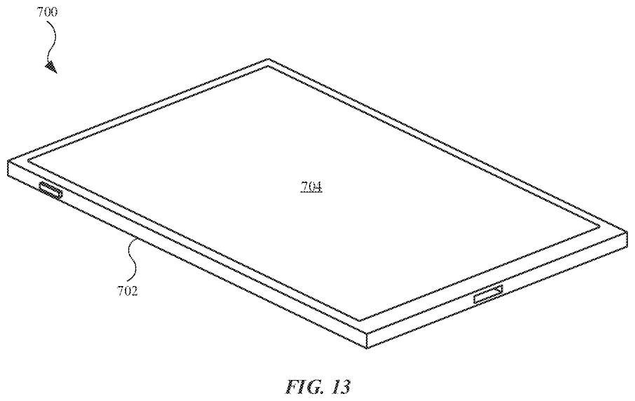

FIGS. 12A, 12B, and 13 show and describe alternate electronic devices. The electronic devices shown and described in FIGS. 12A, 12B, and 13 may incorporate one or more latch systems shown and described herein for the purpose of mechanically interlocking two or more components.

FIGS. 12A and 12B illustrate an isometric view of an alternate embodiment of an electronic device 600. Electronic device 600 may include a desktop computing device or a standalone display device. Electronic device 600 includes a housing 602 used to store internal components. As shown in FIG. 12A, electronic device 600 includes a display 604 secured with housing 602. Additionally, electronic device 600 includes a stand 606 secured with housing 602. In some embodiments, housing 602 (and display 604) are rotatable with respect to stand 606.

In some embodiments, a transparent layer (e.g., cover glass) is positioned over, and secured with, display 604. Using one or more latch systems described herein, housing 602 may be mechanically interlocked with an assembly that includes display 604 and the transparent layer.

FIG. 13 illustrates an isometric view of yet another alternate embodiment of an electronic device 700. Electronic device 700 may include a mobile wireless communication device, such as a smartphone or a tablet computing device. Electronic device 700 includes a housing 702 used to store internal components. Electronic device 700 further includes a display 704 secured with housing 702. In some embodiments, a transparent layer (e.g., cover glass) is positioned over, and secured with, display 704. Using one or more latch systems described herein, housing 702 may be mechanically interlocked with an assembly that includes display 704 and the transparent layer.

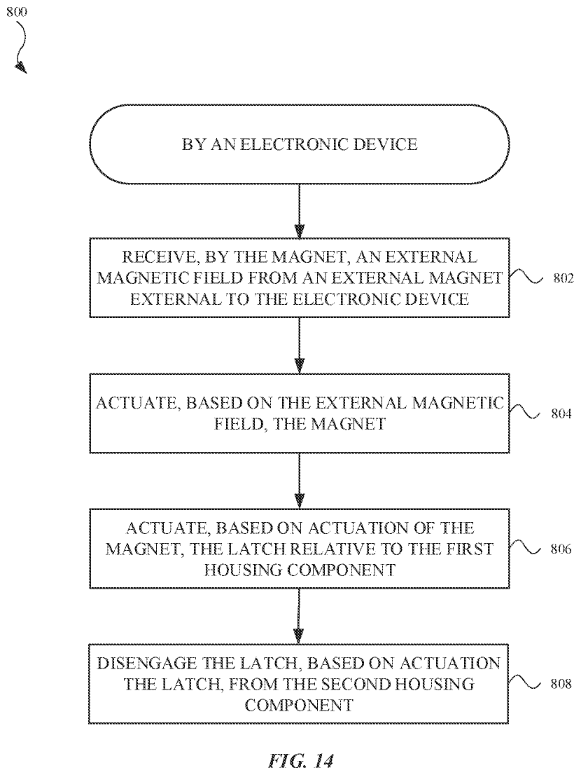

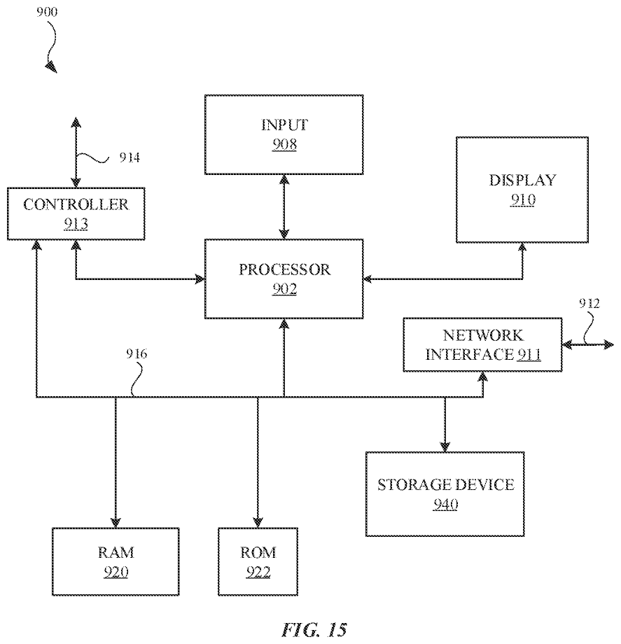

FIG. 14 illustrates a flowchart 800 showing a method for accessing a component located in an electronic device, in accordance with some described embodiments. Flowchart 800 shows and describes the use of a latch system that includes, for example, a post, a magnet, and a latch. Flowchart 800 describes a method that can be implemented by electronic devices described herein.

In step 802, an external magnetic field from an external magnet is received by the magnet. A magnet that is “external” lies outside of the electronic device but nonetheless applies a magnetic field that forms a magnetic circuit with a magnet that is part of a latch positioned in the electronic device. The externally located magnet may be part of a tool used to provide a rotational, or rotary, magnetic field to the magnet within the electronic device.

In step 804, the magnet is actuated based on the external magnetic field. For example, the tool can provide rotational motion to its magnet, thereby causing the magnet within the electronic device to rotate.

In step 806, the latch is actuated, based on actuation of the magnet, relative to the first housing component. In this regard, the latch can rotate in conjunction with the magnet.

In step 808, the latch is disengaged, based on actuation of the latch, from the second housing component. The latch can disengage with the second housing component by being removed from a slot formed in the second housing component. Alternatively, or in combination, the latch can disengage with the second housing component by ceasing physical contact with the second housing component.

FIG. 15 illustrates a block diagram of an electronic device 900, in accordance with some described embodiments. The details shown for electronic device 900 can be used to implement the various techniques described herein, according to some embodiments. In particular,

FIG. 15 shows components that can be included in electronic devices described herein. As shown in FIG. 15, electronic device 900 can include a processor 902 that represents a microprocessor or controller for controlling the overall operation of electronic device 900. Processor 902 represents an exemplary component that is accessible based the latch system described herein allowing separation of housing components. Electronic device 900 can also include a user input device 908 that allows a user of electronic device 900 to interact with electronic device 900. For example, user input device 908 can take a variety of forms, such as a button, keypad, dial, touch screen, audio input interface, visual/image capture input interface, input in the form of sensor data, and so on. Still further, electronic device 900 can include a display 910 that can be controlled by processor 902 (e.g., via a graphics component) to display information to the user. A data bus 916 can facilitate data transfer between at least a storage device 940, processor 902, and a controller 913. Controller 913 can be used to interface with and control different equipment through an equipment control bus 914. Electronic device 900 can also include a network/bus interface 911 that couples to a data link 912. In the case of a wireless connection, network/bus interface 911 can include a wireless transceiver.

As noted above, electronic device 900 also includes storage device 940, which may include a single disk or a collection of disks (e.g., hard drives). In some embodiments, storage device 940 can include flash memory, semiconductor (solid state) memory or the like. Electronic device 900 can also include a Random-Access Memory (RAM) 920 and a Read-Only Memory (ROM) 922. ROM 922 can store programs, utilities or processes to be executed in a non-volatile manner. RAM 920 can provide volatile data storage, and stores instructions related to the operation of applications executing on electronic device 900.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device, comprising:
a housing that defines an internal volume, the housing comprising:
a first housing component, and
a second housing component coupled with the first housing component, the second housing component comprising a slot; and
a latch system coupled to the first housing component, the latch system comprising:
a post extending from the first housing component,
a first magnet and
a second magnet,
a latch magnet coupled with the post and positioned between the first magnet and the second magnet,
a latch coupled with the latch magnet,
wherein:
in response to a rotational magnetic field, provided by an external magnet that is external to the housing, in a first direction, the latch is moved into the slot,
in response to the rotational magnetic field, provided by the external magnet, in a second direction opposite the first direction, the latch is removed from the slot, and the first magnet and the second magnet provide an external magnetic
field configured to prevent rotation of the latch.

2. The electronic device of claim 1, wherein the latch is configured to move from a first position to a second position different from the first position based on the rotational magnetic field applied to the magnet.

3. The electronic device of claim 2, wherein the latch magnet and the latch rotate, based on the external magnetic field, relative to the post, from the first position to the second position.

4. The electronic device of claim 1, wherein the latch rotates from the first position to the second position based on the external magnet rotating to provide the rotational magnetic field.

5. The electronic device of claim 1, wherein the second position comprises the latch rotated out of the slot.

6. The electronic device of claim 1, wherein:
the latch magnet comprises a cylindrical magnet that defines an opening, and the post is positioned in the opening.

7. (canceled)

8. An electronic device, comprising:
a display housing that carries a display;
a base portion rotationally coupled to the display, the base portion comprising:
a first housing component,
a first magnet and a second magnet, wherein the first magnet and the second magnet are coupled to the first housing component, and
a second housing component that combines with the first housing component to define an internal volume, the second housing component comprising a slot; and
a latch system disposed in the internal volume, the latch system comprising:
a post extending from the first housing component,
a latch magnet coupled with the post and positioned between the first magnet and the second magnet, and
a latch coupled with the latch magnet, the latch coupling the first housing component with the second housing component, wherein responsive to an external magnetic field applied to the latch magnet, the latch moves and decouples from the second housing component.

9. The electronic device of claim 8, wherein responsive to the external magnetic field, the latch rotates relative to the post.

10. The electronic device of claim 8, wherein responsive to the external magnetic field, the latch magnet and the latch rotate around the post.

11. The electronic device of claim 8, wherein:
the second housing component comprises a slot; and
the latch coupling with the second housing component at the slot.

12. The electronic device of claim 8, wherein the base portion comprises:
a keyboard; and
a track pad.

13. The electronic device of claim 8, wherein:
the latch magnet comprises a cylindrical magnet that defines an opening, and the post is positioned in the opening.

14. The electronic device of claim 8, wherein the latch system further comprises:
a first magnet; and
a second magnet, wherein:
the magnet is positioned between the first magnet and the second magnet, and the first magnet and the second magnet provide an external magnetic configured to prevent rotation of the latch.

15. A method for accessing a component located in an electronic device, the method comprising, by the electronic device comprising a magnet, a latch, a first housing component, and a second housing component:
receiving, by the magnet, an external magnetic field from an external magnet that is external to the electronic device;
actuating, based on the external magnetic field, the magnet;
actuating, based on actuation of the magnet, the latch relative to the first housing component; and
disengaging the latch, based on actuation of the latch, from the second housing component.

16. The method of claim 15, wherein receiving the external magnetic field comprises receiving a rotating external magnetic field.

17. The method of claim 15, wherein the actuating the magnet comprises rotating the magnet.

18. The method of claim 17, wherein the latch comprises rotating the latch.

19. The method of claim 15, wherein disengaging the latch comprises removing the latch from a slot formed in the second housing component.

20. The method of claim 15, wherein disengaging the latch allows the first housing component to be separated from the second housing component.
